(19) United States
(12) Patent Application Publication
(10) Pub. No.: US 2020/0100540 A1
(43) Pub. Date: Apr. 2, 2020

(54) ELECTRONIC CIGARETTE, AND METHOD AND DEVICE FOR CONTROLLING THE SAME

(71) Applicants: WEIHUA QIU, Ghangzhou City (CN); KUI LIU, Ghangzhou City (CN); NENG HUA, Ghangzhou City (CN)

(72) Inventors: WEIHUA QIU, Ghangzhou City (CN); KUI LIU, Ghangzhou City (CN); NENG HUA, Ghangzhou City (CN)

(21) Appl. No.: 16/147,402

(22) Filed: Sep. 28, 2018

(51) Int. Cl. A24F 47/00; H05B 1/02

(52) U.S. Cl. CPC A24F 47/008; H05B 2203/021; H05B 1/0227; H05B 1/0202

(57) ABSTRACT

Provided are an electronic cigarette, and a method and a device for controlling the same. A battery in the electronic cigarette is connected to an atomizing device through a first power supply circuit, and to a first detecting device through a second power supply circuit, where first information detected by the first detecting device is configured to indicate whether the electronic cigarette is in a state of being sucked. An on-off key is configured to control a connectivity of the first power supplying circuit, second information detected by a second detecting device is configured to indicate a position of a switching member, a microcontroller unit (MCU) controls a connectivity of the second power supplying circuit according to the second information, and the MCU controls the connectivity of the first power supplying circuit according to the first information in case that the second power supplying circuit is closed.

### CROSS-REFERENCE TO RELATED APPLICATION

This application claims priority to Chinese Patent Application No. 201710908024.0, filed on Sep. 29, 2017, which is hereby incorporated by reference in its entirety.

### TECHNICAL FIELD

The present disclosure relates to the technical field of smoking-simulating, and particularly to an electronic cigarette, and a method and a device for controlling the same.

### BACKGROUND

An electronic cigarette is an electronic product that simulates cigarettes, and heats smoke oil in a cartridge through an atomizing device to atomize the smoke oil and generate vapor, which can be inhaled by a user from a cigarette holder, so as to simulate smoking.

Since the atomizing device of the electronic cigarette generate the heat using a heating wire and is powered by a battery arranged within the electronic cigarette, the atomizing device only needs to generate the heat when the electronic cigarette is in use, and shall be powered off at other times. Therefore, the electronic cigarette is usually provided with an on-off key, allowing the user to manually “light” the cigarette by pressing the key. At present, an electronic cigarette that supports automatic lighting is also on the market, which enables the user to trigger an operation of the atomizing device in the electronic cigarette by directly sucking at the cigarette holder. However, so far, there is no such an electronic cigarette that integrates both the manual and automatic cigarette lightings and supports free switching between the two. Instead, each model of the electronic cigarettes available on the market only provides a single way to light the cigarettes.

### SUMMARY

In order to solve the problem in the prior art that each model of the electronic cigarettes only provides a single way to light the cigarettes, embodiments of the present disclosure provide an electronic cigarette and a method for controlling the same, the technical solutions are as follows:

In a first aspect, an electronic cigarette is provided, the electronic cigarette includes a first detecting device, an atomizing device and a battery, where the battery is connected to the atomizing device through a first power supplying circuit, and the battery is connected to the first detecting device through a second power supplying circuit, the battery is configured to supply power to the atomizing device and the first detecting device, and first information detected by the first detecting device is configured to indicate whether the electronic cigarette is in a state of being sucked; where the electronic cigarette is further provided with a switching member, the electronic cigarette further includes: an on-off key, a second detecting device and a microcontroller unit (MCU), where the on-off key is configured to control a connectivity of the first power supplying circuit, second information detected by the second detecting device is configured to indicate a position of the switching member, the MCU is configured to control a connectivity of the second power supplying circuit according to the second information, and the MCU is further configured to control the connectivity of the first power supplying circuit according to the first information in case that the second power supplying circuit is closed.

In an embodiment, the electronic cigarette may further include a cigarette holder and an air passage, where the air passage communicates with the cigarette holder, and the second detecting device is disposed outside an end of the air passage closer to a seat.

In an embodiment, the switching member is capable of being displaced to a first position or a second position; the switching member includes the seat and a pushing piece that are connected to each other, the pushing piece is provided on an housing of the electronic cigarette, and the seat is provided within the housing of the electronic cigarette.

In an embodiment, the seat is provided with a shading slider on a side facing the air passage, and the second detecting device is a photosensitive sensor, when the switching member is at the first position, all or part of the shading slider is within the air passage; and a portion of the shading slider that is within the air passage is reduced in volume while the switching member is moved from the first position to the second position.

In an embodiment, the seat is a magnetic member, and the second detecting device is a Hall sensor, and a distance between the Hall sensor and the seat gradually increase and a magnetic force detected by the Hall sensor gradually decreases while the switching member is moved from the first position to the second position.

In an embodiment, the seat of the switching member is provided with a catcher, the catcher catches the on-off key when the switching member is displaced to the second position; and the catcher disengages from the on-off key completely when the switching member is displaced to the first position.

In an embodiment, the catcher is oriented towards the on-off key.

In an embodiment, the on-off key is provided with a catching step, the catching step engages into the catcher to catch the on-off key when the switching member is displaced to the second position; the catching step disengages from the catcher when the switching member is displaced to the first position.

In an embodiment, in case that the second power supplying circuit is closed, the MCU controls the connectivity of the first power supplying circuit according to the first information, and stops controlling the connectivity of the first power supplying circuit according to a pressing signal corresponding to the on-off key.

In an embodiment, the second power supplying circuit is provided with a transistor whose base electrode is connected to the MCU, and the MCU controls the connectivity of the second power supplying circuit by controlling a current inputted by the MCU to the base electrode.

In an embodiment, the first power supplying circuit is provided with an electronic switch, whose control end is connected to the MCU, and the MCU controls opening and closing of the electronic switch.

In an embodiment, the first detecting device is an air pressure sensor, an air flow sensor, a pressure sensor or a temperature sensor.

In a second aspect, a method for controlling an electronic cigarette is provided, the method is applicable to the MCU in the electronic cigarette provided in the first aspect, the method includes: obtaining second information detected by a second detecting device, where the second information is configured to indicate a position of a switching member; when the second information indicates that the switching member is at a first position, controlling a second power supplying circuit between a first detecting device and a battery to be open, where first information detected by the first detecting device is configured to indicate whether the electronic cigarette is in a state of being sucked; when the second information indicates that the switching member is at a second position, controlling the second power supplying circuit to be closed, and controlling a connectivity of a first power supplying circuit according to the first information reported by the first detecting device, where the battery is connected to an atomizing device through the first power supplying circuit.

In an embodiment, the method further includes: in case that the second power supplying circuit is closed, stopping controlling the connectivity of the first power supplying circuit according to a pressing signal corresponding to an on-off key.

In an embodiment, the switching member includes a seat and a pushing piece, the second detecting device is disposed outside an end of the air passage closer to the seat, a side of the seat of the switching member facing the air passage is provided with a shading slider, the second detecting device is a photosensitive sensor, and the second information is a light intensity; the method further includes: when the light intensity is lower than a first value, determining that the switching member is at the first position; when the light intensity is higher than a second value, determining that the switching member is at the second position, where the first value is less than or equal to the second value.

In an embodiment, the switching member includes a seat and a pushing piece, the second detecting device is disposed outside an end of the air passage closer to the seat, the seat is a magnetic member, the second detecting device is a Hall sensor, and the second information is a magnetic force value; the method further includes: when the magnetic force value obtained by the second detecting device is higher than a third value, determining that the switching member is at the first position; when the magnetic force value obtained by the second detecting device is lower than a fourth value, determining that the switching member is at the second position, where the third value is greater than or equal to the fourth value.

In an embodiment, the method further includes: in case that the second power supplying circuit is opened, controlling the connectivity of the first power supplying circuit according to a pressing signal corresponding to the on-off key.

In a third aspect, a controlling device for an electronic cigarette is provided, the device includes: an obtaining device, configured to obtain second information detected by a second detecting device, where the second information is configured to indicate a position of a switching member; a first controlling device, configured to, when the second information indicates that the switching member is at a first position, control a second power supplying circuit between a first detecting device and a battery to be open, where first information detected by the first detecting device is configured to indicate whether the electronic cigarette is in a state of being sucked; a second controlling device, configured to, when the second information indicates that the switching member is at a second position, control the second power supplying circuit to be closed, and control a connectivity of a first power supplying circuit according to the first information reported by the first detecting device, where the battery is connected to an atomizing device through the first power supplying circuit.

In an embodiment, the first controlling device is further configured to, in case that the second power supplying circuit is opened, control the connectivity of the first power supplying circuit according to a pressing signal corresponding to the on-off key.

In an embodiment, the second controlling device is further configured to, in case that the second power supplying circuit is closed, stop controlling the connectivity of the first power supplying circuit according to a pressing signal corresponding to an on-off key.

A fourth aspect provides a controlling device for an electronic cigarette, the device includes a memory and a processor, where the memory stores at least one program instruction, the processor loads and executes the at least one program instruction stored in the memory to implement the method for controlling an electronic cigarette as described in the second aspect above.

The technical solutions provided by the embodiments of the present disclosure may bring about the following advantageous effects:

The second detecting device detects and obtains second information for indicating the position of the switching member; the MCU controls the connectivity of the second power supplying circuit between the first detecting device and the battery according to the second information, so as to control whether the battery supplies power to the first detecting device for the first detecting device to detect and obtain the first information, where the first information is configured to indicate whether the electronic cigarette is in the state of being sucked; in case that the second power supplying circuit is closed, the MCU controls the connectivity of the first power supplying circuit between the atomizing device and the battery according to the first information detected by the first detecting device, so as to realize automatic cigarette lighting; in case that the second power supplying circuit is open, the user may also controls the connectivity of the first power supplying circuit between the atomizing device and the battery via the on-off key, so as to realize manual cigarette lighting. In this technical solution, the user controls the connectivity of the second power supplying circuit by manipulating the position of the switching member, so that the electronic cigarette can be automatically lit in case that the second power supplying circuit is closed, or be manually lit in case that the second power supplying circuit is open. Therefore, this technical solution solves the problem in related art that each model of the electronic cigarettes only provides a single way to light the cigarettes, achieving the effect of enriching lighting manner provided by the electronic cigarette.

### BRIEF DESCRIPTION OF DRAWINGS

A brief introduction will be given hereinafter to the accompany drawings which will be used in the description of the embodiments in order to explain the technical solutions of the present disclosure more clearly. Apparently, the drawings in the description below are merely illustrating some embodiments of the present disclosure. Those skilled in the art may obtain other drawings according to these drawings without paying any creative labor.

FIG. 1 is a schematic structural view illustrating an electronic cigarette according to an embodiment of the present disclosure;

FIG. 2 is a schematic structural view illustrating an electronic cigarette in an automatic mode according to an embodiment of the present disclosure;

FIG. 3 is a flowchart illustrating a method for controlling an electronic cigarette according to an embodiment of the present disclosure; and

FIG. 4 is a schematic device diagram illustrating a controlling device for an electronic cigarette according to an embodiment of the present disclosure.

### DESCRIPTION OF EMBODIMENTS

To make the objectives, technical resolutions and advantages of the present disclosure more clearly, embodiments of the present disclosure will be further described in more detailed hereinafter in conjunction with the accompany drawings.

The names and labels of the various components in the drawing are referred in Table 1, which is as follows:

| | | | |
|---|---|---|---|
| Atomizing device: 1 | Controlling panel: 2 | First detecting device: 3 | On-off key: 4 |
| Battery: 6 | Cigarette holder: 8 | Connecting member: 9 | Airway: 31 |
| Air inlet: 32 | Catching step: 41 | Pushing piece: 51 | Seat: 52 |
| Catcher: 54 | Housing: 71 | Bottom cover: 72 | Air passage: 91 |
| Second detecting device: 33 | | | |

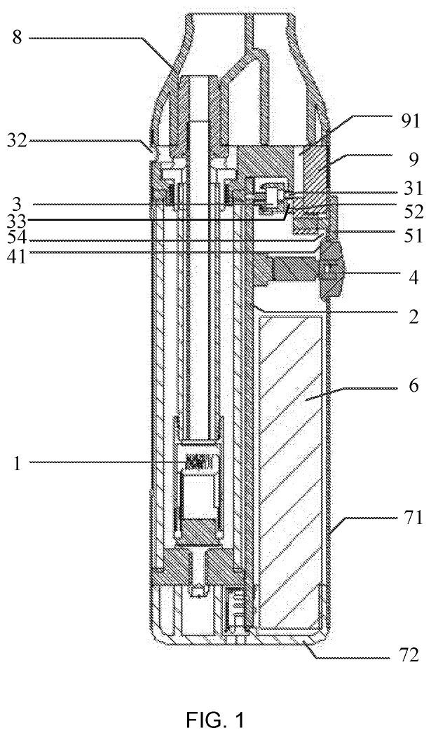

FIG. 1 is a schematic structural view illustrating an electronic cigarette according to an embodiment of the present disclosure. At this moment, the electronic cigarette is in a mechanical mode that allows a user to manually light the cigarette. Referring to FIG. 1, the electronic cigarette includes a housing 71 which is provided with an air inlet 32 thereon. A bottom of the housing 71 is provided with a bottom cover 72 which can be connected to the housing 71 by an interference fit.

An upper end of the housing 71 is provided with a connecting member 9, which is also connected to the housing 71 by an interference fit. A cigarette holder 8 of the electronic cigarette is connected to the connecting member 9 by a detachable connecting means, such as a pluggable means, and the cigarette holder 8 communicates with an air passage 91.

Still referring to FIG. 1, a controlling board 2, an atomizing device 1, and a battery 6 are disposed within the housing 71 of the electronic cigarette. The controlling board 2 is disposed in the middle section of the housing 71, and the atomizing device 1 and the battery 6 are respectively disposed in two sides of the controlling board 2.

The battery 6 is connected to the atomizing device 1 through a first power supplying circuit. When the first power supplying circuit is closed, the battery 6 supplies power to the atomizing device 1.

Still referring to FIG. 1, the on-off key 4 of the electronic cigarette is limited between the controlling board 2 and the housing 71. Part of the on-off key 4 are outside the housing 71 while some parts are inside the housing 71. The user may manually light the cigarette by pressing the part of the on-off key 4 outside the housing 71.

When the on-off key 4 is pressed, a microcontroller unit (MCU) provided on the controlling board 2 may receive a pressing signal generated when the on-off key 4 is pressed. At this time, the MCU can put the first power supplying circuit to be closed, enabling the battery 6 to supply power to the atomizing device 1. Thus, the user may trigger the atomizing device 1 of the electronic cigarette to begin an atomization process by pressing the on-off key 4, realizing manual cigarette lighting.

In one of the embodiments, the first power supplying circuit may be provided with an electronic switch, whose control end is connected to the MCU. The MCU controls opening and closing of the electronic switch, thereby implementing the MCU's control of a connectivity of the first power supplying circuit.

Still referring to FIG. 1, the electronic cigarette further includes a first detecting device 3 which is disposed at an upper end of the controlling board 2 at a position near the connecting member 9. An airway 31 of the first detecting device 3 should directly or indirectly communicates with an inside of the aforementioned air passage 91.

First information detected by the first detecting device 3 is configured to indicate whether the electronic cigarette is in a state of being sucked. For example, when the user sucks at the cigarette holder 8 of the electronic cigarette, the electronic cigarette is considered to be in the state of being sucked. This embodiment will be described with the first detecting device 3 being an air pressure sensor and an air flow sensor, respectively. In actual implementation, the first detecting device 3 may also be other types of sensors, such as a pressure sensor, a temperature sensor or the like.

Optionally, the first detecting device 3 may be an air pressure sensor that is connected to the MCU. The air pressure sensor may report detected air pressure data to the MCU. When the user sucks at the cigarette holder 8, an air pressure within the air passage 91 changes, and since the airway 31 of the air pressure sensor can directly or indirectly communicate with the air passage 91, the air pressure data detected by the air pressure sensor also changes. Thus, the first information detected by the first detecting device 3, i.e., the air pressure data detected by the air pressure sensor, may be configured to indicate whether the electronic cigarette is in the state of being sucked.

When the MCU confirms that the electronic cigarette is in the state of being sucked according to the first information reported by the first detecting device 3, the MCU may control the first power supplying circuit to be closed, enabling the battery 6 to supply power to the atomizing device 1. Thus, the user may trigger an atomizing operation of the atomizing device 1 by directly sucking at the cigarette holder 8 to realize automatic cigarette lighting, without needing the user to press the on-off key 4 to manually light the cigarette.

Specifically, the above may be implemented as follows: the MCU receives the air pressure data reported by the first detecting device 3; and when the air pressure data meets a preset condition, the first power supplying circuit is controlled to be closed. In this embodiment, the preset condition will not be specifically defined. For example, the preset condition may include any one or more of that the air pressure data reported by the first detecting device 3 is below a preset air pressure value, or that the amount of change in the air pressure data reported by the first detecting device 3 is above a preset values, or the like.

Optionally, the first detecting device 3 may be an air flow sensor which can be configured to detect air flow information. The air flow information may include a flow rate, a flow direction, and/or the like of the air. When the air flow information obtained by the MCU from the air flow sensor indicates that the electronic cigarette is in the state of being sucked, the MCU controls the first power supplying circuit to be closed, enabling the battery 6 to supply power to the atomizing device 1. For example, when the air flow obtained by the MCU from the air flow sensor exceeds a preset flow rate value, it is determined that a suction behavior is happening, and hence the first power supplying circuit may be controlled to be closed.

In order to facilitate the user to control the manner of lighting the electronic cigarette, the electronic cigarette further includes a switching member. The switching member consists of a seat 52 and a pushing piece 51. The pushing piece 51 is disposed on the housing 71 of the electronic cigarette, and the seat 52 is disposed within the housing 71 of the electronic cigarette.

The housing 71 has an opening provided for the switching member, through which the pushing piece 51 of the switching member extends out of the housing 71. The user may push the pushing piece 51 to cause the switching member to be at a first position or a second position. It should be noted that this embodiment will be illustrated by way of an example in which the first position is a limit position of the switching member to which the switching member may be pushed upward with respect to the opening, and the second position is a limit position of the switching member to which the switching member may be pushed downward with respect to the opening. In actual implementation, the first position may be part of the area within the opening, and the second position is located below the first position. This embodiment will be illustrated by way of an example in which an electronic cigarette may be manually lit when the switching member is at the first position and may be automatically lit when the switching member is at the second position.

Still referring to FIG. 1, the electronic cigarette further includes a second detecting device 33, second information detected by the second detecting device 33 is configured to indicate the position of the switching member. The second detecting device 33 is connected to the MCU, and feeds the second information that it detects back to the MCU in real time. The MCU controls a connectivity of a second power supplying circuit between the battery 6 and the first detecting device 3 according to the second information.

When the second information received by the MCU indicates that the switching member is at the second position, which means that the user has selected an automatic cigarette lighting mode. Then, the electronic cigarette needs the first detecting device 3 to be in a working state to monitor whether the user is sucking at the cigarette holder 8. At this time, the MCU controls the second power supplying circuit between the battery 6 and the first detecting device 3 to be closed, enabling the battery 6 to supply power to the first detecting device 3. Additionally, the MCU controls the connectivity of the first power supplying circuit between the atomizing device 1 and the battery 6 according to the first information detected by the first detecting device 3, where the first information is configured to indicate whether the electronic cigarette is in the state of being sucked, realizing automatic cigarette lighting.

When the second information received by the MCU indicates that the switching member is at the first position, which means that the user has selected a manual cigarette lighting mode. Then, the electronic cigarette does not need the first detecting device 3 to be in the working state, and the MCU may control the second power supplying circuit between the battery 6 and the first detecting device 3 to be open, causing the battery 6 to stop supplying power to the first detecting device 3, thus reducing the power consumption of the battery 6.

In the electronic cigarette provided in this embodiment, the second detecting device 33 detects and obtains second information for indicating the position of the switching member; the MCU controls the connectivity of the second power supplying circuit between the first detecting device 3 and the battery 6 according to the second information, so as to control whether the battery 6 supplies power to the first detecting device 3 for the first detecting device 3 to detect and obtain the first information, where the first information is configured to indicate whether the electronic cigarette is in the state of being sucked; in case that the second power supplying circuit is closed, the MCU controls the connectivity of the first power supplying circuit between the atomizing device 1 and the battery according to the first information detected by the first detecting device 3, so as to realize automatic cigarette lighting; in case that the second power supplying circuit is open, the user may also controls the connectivity of the first power supplying circuit between the atomizing device 1 and the battery 6 via the on-off key 4, so as to realize manual cigarette lighting. In this embodiment, the user controls the connectivity of the second power supplying circuit by manipulating the position of the switching member, so that the electronic cigarette can be automatically lit in case that the second power supplying circuit is closed, or be manually lit in case that the second power supplying circuit is open. Therefore, this technical solution solves the problem in related art that each model of the electronic cigarettes only provides a single way to light the cigarettes, achieving the effect of enriching lighting manner provided by the electronic cigarette.

Optionally, in an example, the second power supply circuit between the battery 6 and the first detecting device 3 is provided with a transistor, whose base electrode is connected to the MCU. The MCU controls a connectivity of the transistor through the base electrode of the transistor, in turn controlling the connectivity of the second power supply circuit. For example, the transistor can be a MOS transistor.

Optionally, in an example, the second detecting device 33 is disposed outside an end of the air passage 91 closer to the seat 52, and the second detecting device 33 is a photosensitive sensor. A side of the seat 52 of the switching member facing the air passage 91 is provided with a shading slider.

The photosensitive sensor (i.e., the second detecting device 33) is connected to the MCU, the second detecting device 33 transmits a detected light intensity (i.e., the second information) to the MCU in real time. The second information may be configured to indicate the position of the switching member for the following reasons:

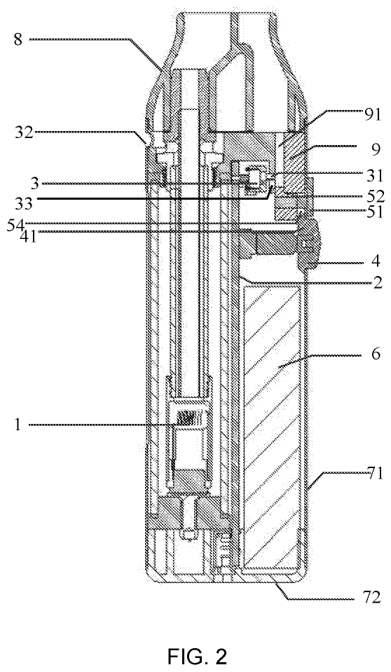

when the switching member is at the first position, referring to FIG. 1, all or part of the shading slider is within the air passage 91. While the switching member is moved from the first position to the second position, a portion of the shading slider that is within the air passage 91 is reduced in volume, and the light intensity detected by the second detecting device 33 is increased. Optionally, when the switching member is at the second position, all of the shading sliders is separated from the air passage 91, as shown in FIG. 2.

It can be seen that the light intensity detected by the second detecting device 33 when the switching member is at the first position is lower than the light intensity detected by the second detecting device 33 when the switching member is at the second position. Thus, the second information (i.e., the light intensity) detected by the second detecting device 33 can be configured to indicate the position of the switching member.

When the MCU receives the light intensity transmitted from the second detecting device 33, the MCU controls the connectivity of the second power supplying circuit between the battery 6 and the first detecting device 3 based on the light intensity. For example, when the light intensity received by the MCU is lower than a first value, the switching member is considered to be at the first position, and the MCU controls the second power supplying circuit to be open, and the battery 6 does not supply power to the first detecting device 3.

For another example, the first value may be less than or equal to a second value. When the light intensity received by the MCU is higher than the second value, the switching member is considered to be at the second position, and the MCU controls the second power supplying circuit to be closed, enabling the battery 6 to supply power to the first detecting device 3, and the first detecting device 3 feeds the first information, which is configured to indicate whether the electronic cigarette is in the state of being sucked, back to the MCU for the MCU to control the connectivity of the first power supplying circuit between the atomizing device 1 and the battery 6 according to the first information to realize automatic cigarette lighting.

Optionally, in an example, the second detecting device 33 is disposed outside the end of the air passage 91 closer to the seat 52, and the second detecting device 33 is a Hall sensor, and the seat 52 of the switching member is a magnetic member. The second detecting device 33 is connected to the MCU and transmits a detected magnetic force (i.e., the second information) to the MCU in real time.

The second information detected by the second detecting device 33 can be configured to indicate the position of the switching member for the following reasons:

while the switching member is moved from the first position to the second position, a distance between the seat 52 and the Hall sensor gradually increases, and the magnetic force detected by the second detecting device 33 gradually decreases. As can be seen, the magnetic force detected by the second detecting device 33 when the switching member is at the first position is lower than the magnetic force detected by the second detecting device 33 when the switching member is at the second position. Thus, the MCU may use the second information (i.e., degree of the magnetic force) reported by the second detecting device 33 to indicate the position of the switching member.

The MCU controls the connectivity of the second power supplying circuit between the battery 6 and the first detecting device 3 based on the magnitude of the magnetic force value acquired by the second detecting device 33. For example, when the magnetic force obtained by the second detecting device 33 is higher than a third value, the switching member is considered to be at the first position, and the MCU controls the second power supplying circuit to be open, and the battery 6 does not supply power to the first detecting device 3.

For another example, the third value is greater than or equal to a fourth value. When the magnetic force received by the MCU is lower than the fourth value, the switching member is considered to be at the second position, and the MCU controls the second power supplying circuit to be closed, enabling the battery 6 to supply power to the first detecting device 3, and the first detecting device 3 feeds the first information, which is configured to indicate whether the user is sucking at the cigarette holder 8, back to the MCU for the MCU to control the connectivity of the first power supplying circuit between the atomizing device 1 and the battery 6 according to the first information to realize automatic cigarette lighting.

Optionally, in an example, in order to prevent the user from manually lighting the cigarette in case that the switching member has been displaced to the second position to select automatic cigarette lighting, a catcher 54 is provided on the switching member of the electronic cigarette. The catcher 54 is oriented towards the on-off key 4.

When the switching member is displaced to the second position, the catcher 54 catches the on-off key 4, disabling pressing operation on the on-off key 4. Specifically, as shown in FIG. 2, the on-off key 4 is provided with a catching step 41. When the switching member is displaced to the second position, the catching step 41 on the on-off key 4 engages into the catcher 54, disabling pressing operation on the on-off key 4. Thus, when the user has displaced the switching member to the second position to select automatic cigarette lighting, the user is unable to manually light the cigarette by pressing the on-off key 4.

When the switching member is displaced to the first position, the catcher 54 is disengaged from the on-off key 4 completely. Specifically, the catcher 54 is disengaged from the catching step 41 of the on-off key 4 completely, so that the on-off key 4 can be pressed. Thus, in case that the user has displaced the switching member to the first position to select manual cigarette lighting, the user can manually light the cigarette by pressing the on-off key 4.

Optionally, in an example, in order to disable the user from manually lighting the cigarette by pressing the on-off key 4 in case that the user has displaced the switching member to the second position to select automatic cigarette lighting, the MCU in the electronic cigarette can further perform the following operations: in case that the second power supplying circuit between the first detecting device 3 and the battery 6 is closed, the MCU controls the connectivity of the first power supplying circuit according to the first information acquired from the first detecting device 3, and stops controlling the connectivity of the first power supplying circuit according to a pressing signal corresponding to the on-off key 4, where the first information is configured to indicate whether the electronic cigarette is in the state of being sucked.

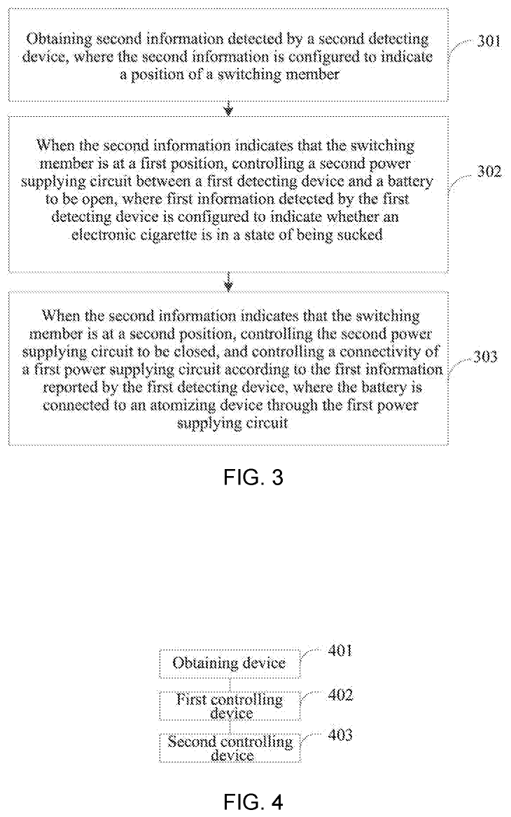

FIG. 3 is a flowchart illustrating a method for controlling an electronic cigarette according to an embodiment of the present disclosure. The method is applicable to the MCU in the electronic cigarettes shown in FIGS. 1 and 2. As shown in FIG. 3, the method may include the following steps:

Step 301: obtaining second information detected by a second detecting device, where the second information is configured to indicate a position of the switching member.

After performing Step 301, Step 302 or 303 can be performed.

Step 302: when the second information indicates that the switching member is at a first position, controlling a second power supplying circuit between a first detecting device and a battery to be open, where first information detected by the first detecting device is configured to indicate whether the electronic cigarette is in a state of being sucked.

In case that the second detecting device is a photosensitive sensor and the second information is a light intensity detected by the second detecting device, this step may be implemented by: when the light intensity obtained by the MCU from the second detecting device is lower than a preset first value, the MCU controls the second power supplying circuit to be open.

In case that the second detecting device is a Hall sensor and the second information is a magnetic force, this step may be implemented by: when the magnetic force obtained by the MCU from the second detecting device is higher than a third value, the MCU controls the second power supplying circuit to be open.

Step 303: when the second information indicates that the switching member is at a second position, controlling the second power supplying circuit to be closed, and controlling a connectivity of a first power supplying circuit according to the first information reported by the first detecting device, where the battery is connected to an atomizing device through the first power supplying circuit.

In case that the second detecting device is the photosensitive sensor and the second information is the light intensity detected by the second detecting device, this step may be implemented by: when the light intensity obtained by the MCU from the second detecting device is higher than a preset second value, the MCU controls the second power supplying circuit to be closed, where the second value is greater than or equal to the first value.

In case that the second detecting device is the Hall sensor and the second information is the magnetic force, this step may be implemented by: when the magnetic force obtained by the MCU from the second detecting device is lower than a fourth value, the MCU controls the second power supplying circuit to be closed, where the fourth value is greater than or equal to the third value.

Optionally, after Step 303 is performed, Step 304 may be further performed.

Step 304: stopping controlling the connectivity of the first power supplying circuit according to a pressing signal corresponding to the on-off key.

In view of foregoing, in the method provided in this embodiment, the second detecting device to detects and obtains second information for indicating a position of the switching member; the MCU controls a connectivity of the second power supplying circuit between the first detecting device and the battery according to the second information, so as to control whether the battery supplies power to the first detecting device for the first detecting device to detect and obtain the first information, where the first information is configured to indicate whether the electronic cigarette is in the state of being sucked; in case that the second power supplying circuit is closed, the MCU controls the connectivity of the first power supplying circuit between the atomizing device and the battery according to the first information detected by the first detecting device, so as to realize automatic cigarette lighting; in case that the second power supplying circuit is open, the user may also controls the connectivity of the first power supplying circuit between the atomizing device and the battery via the on-off key, so as to realize manual cigarette lighting. Since the user controls the connectivity of the second power supplying circuit by manipulating the position of the switching member, the electronic cigarette can be automatically lit in case that the second power supplying circuit is closed, or be manually lit in case that the second power supplying circuit is open. Therefore, the problem in related art that each model of the electronic cigarettes only provides a single way to light the cigarettes is solved, achieving the effect of enriching lighting manner provided by the electronic cigarette.

The embodiments further provide a computer storage medium storing at least one program instruction therein, the at least one program instruction may be loaded and executed by a processor in the electronic cigarette to implement the controlling method shown in FIG. 3.

FIG. 4 is a flowchart illustrating a controlling device for an electronic cigarette according to an embodiment of the present disclosure. The device may include all or part of the MCU in the electronic cigarette as shown in FIGS. 1 and 2. The controlling device may include:

an obtaining device 401, configured to obtain second information detected by a second detecting device, where the second information is configured to indicate a position of a switching member;

a first controlling device 402, configured to 1, when the second information obtained by the obtaining device 401 indicates that the switching member is at a first position, control a second power supplying circuit between a first detecting device and a battery to be open, where first information detected by the first detecting device is configured to indicate whether the electronic cigarette is in a state of being sucked;

a second controlling device 403, configured to, when the second information obtained by the obtaining device 401 indicates that the switching member is at a second position, control the second power supplying circuit to be closed, and control a connectivity of a first power supplying circuit according to the first information reported by the first detecting device, where the battery is connected to an atomizing device through the first power supplying circuit.

Optionally, the second controlling device 403 is further configured to, in case that the second power supplying circuit is closed, stop controlling the connectivity of the first power supplying circuit according to a pressing signal corresponding to an on-off key.

In view of foregoing, in the device provided in this embodiment, the second detecting device to detects and obtains second information for indicating a position of the switching member; the MCU controls a connectivity of the second power supplying circuit between the first detecting device and the battery according to the second information, so as to control whether the battery supplies power to the first detecting device for the first detecting device to detect and obtain the first information, where the first information is configured to indicate whether the electronic cigarette is in the state of being sucked; in case that the second power supplying circuit is closed, the MCU controls the connectivity of the first power supplying circuit between the atomizing device and the battery according to the first information detected by the first detecting device, so as to realize automatic cigarette lighting; in case that the second power supplying circuit is open, the user may also controls the connectivity of the first power supplying circuit between the atomizing device and the battery via the on-off key, so as to realize manual cigarette lighting. Since the user controls the connectivity of the second power supplying circuit by manipulating the position of the switching member, the electronic cigarette can be automatically lit in case that the second power supplying circuit is closed, or be manually lit in case that the second power supplying circuit is open. Therefore, the problem in related art that each model of the electronic cigarettes only provides a single way to light the cigarettes is solved, achieving the effect of enriching lighting manner provided by the electronic cigarette.

An embodiment also provides a controlling device for an electronic cigarette, the device includes a memory and a processor, where the memory stores at least one program instruction, the processor loads and executes the at least one program instruction stored in the memory to implement the method for controlling an electronic cigarette as described in the embodiments above.

It should be noted that, when controlling the electronic cigarette, the controlling device provided in the above embodiment is only exemplified by the division of the above-mentioned procedural devices. In actual application, the above functions may be assigned to and completed by different procedural devices as needed, that is, the internal structure of the MCU may be divided into different procedural devices to accomplish all or part of the functions described above. In addition, the controlling device and controlling method embodiments provided by the foregoing embodiments belong to the same concept, and details in the specific implementation processes are described in the method embodiment, which will not be repeated herein.

The above serial numbers of the embodiments of the present disclosure are merely for the description, and do not represent the advantages or disadvantages of the embodiments.

A person skilled in the art can understand that all or part of the steps for implementing the above embodiments may be accomplished by a hardware alone or by a program instructing a relative hardware, where the program may be stored in a computer readable storage medium that may be a read only memory, a magnetic disk or an optical disk or the like.

The above descriptions are only preferred embodiments of, rather than limitations on, the present disclosure. Any modifications, equivalents, improvements, etc., within the spirit and scope of the present disclosure should be included in the protection scope of the present disclosure.

What is claimed is:

1. An electronic cigarette, comprising a first detecting device, an atomizing device and a battery, wherein the battery is connected to the atomizing device through a first power supplying circuit, and the battery is connected to the first detecting device through a second power supplying circuit, the battery is configured to supply power to the atomizing device and the first detecting device, and first information detected by the first detecting device is configured to indicate whether the electronic cigarette is in a state of being sucked;
wherein the electronic cigarette is further provided with a switching member, the electronic cigarette further comprises: an on-off key, a second detecting device and a microcontroller unit (MCU), wherein the on-off key is configured to control a connectivity of the first power supplying circuit, second information detected by the second detecting device is configured to indicate a position of the switching member, the MCU is configured to control a connectivity of the second power supplying circuit according to the second information, and the MCU is further configured to control the connectivity of the first power supplying circuit according to the first information in case that the second power supplying circuit is closed.

2. The electronic cigarette according to claim 1, further comprising a cigarette holder and an air passage, wherein the air passage is communicates with the cigarette holder, and the second detecting device is disposed outside an end of the air passage closer to a seat.

3. The electronic cigarette according to claim 2, wherein the switching member is capable of being displaced to a first position or a second position; the switching member comprises the seat and a pushing piece that are connected to each other, the pushing piece is provided on an housing of the electronic cigarette, and the seat is provided within the housing of the electronic cigarette.

4. The electronic cigarette according to claim 3, wherein the seat is provided with a shading slider on a side facing the air passage, and the second detecting device is a photosensitive sensor,
when the switching member is at the first position, all or part of the shading slider is within the air passage; and
a portion of the shading slider that is within the air passage is reduced in volume while the switching member is moved from the first position to the second position.

5. The electronic cigarette according to claim 3, wherein the seat is a magnetic member, and the second detecting device is a Hall sensor, and
a distance between the Hall sensor and the seat gradually increase and a magnetic force detected by the Hall sensor gradually decreases while the switching member is moved from the first position to the second position.

6. The electronic cigarette according to claim 3, wherein the seat of the switching member is provided with a catcher,
the catcher catches the on-off key when the switching member is displaced to the second position; and
the catcher disengages from the on-off key completely when the switching member is displaced to the first position.

7. The electronic cigarette according to claim 6, wherein the catcher is oriented towards the on-off key.

8. The electronic cigarette according to claim 6, wherein the on-off key is provided with a catching step,
the catching step engages into the catcher to catch the on-off key when the switching member is displaced to the second position;
the catching step disengages from the catcher when the switching member is displaced to the first position.

9. The electronic cigarette according to claim 1, wherein, in case that the second power supplying circuit is closed, the MCU controls the connectivity of the first power supplying circuit according to the first information, and stops controlling the connectivity of the first power supplying circuit according to a pressing signal corresponding to the on-off key.

10. The electronic cigarette according to claim 1, wherein the second power supplying circuit is provided with a transistor whose base electrode is connected to the MCU, and the MCU controls the connectivity of the second power supplying circuit by controlling a current inputted by the MCU to the base electrode.

11. The electronic cigarette according to claim 1, wherein the first power supplying circuit is provided with an electronic switch, whose control end is connected to the MCU, and the MCU controls opening and closing of the electronic switch.

12. The electronic cigarette according to claim 1, wherein the first detecting device is an air pressure sensor, an air flow sensor, a pressure sensor or a temperature sensor.

13. A method for controlling an electronic cigarette, being applicable to the MCU in the electronic cigarette according to claim 1, and comprising:
obtaining second information detected by a second detecting device, wherein the second information is configured to indicate a position of a switching member;
when the second information indicates that the switching member is at a first position, controlling a second power supplying circuit between a first detecting device and a battery to be open, wherein first information detected by the first detecting device is configured to indicate whether the electronic cigarette is in a state of being sucked;
when the second information indicates that the switching member is at a second position, controlling the second power supplying circuit to be closed, and controlling a connectivity of a first power supplying circuit according to the first information reported by the first detecting device, wherein the battery is connected to an atomizing device through the first power supplying circuit.

14. The method according to claim 13, further comprising:
in case that the second power supplying circuit is closed, stopping controlling the connectivity of the first power supplying circuit according to a pressing signal corresponding to an on-off key.

15. The method according to claim 13, wherein the switching member comprises a seat and a pushing piece, the second detecting device is disposed outside an end of the air passage closer to the seat, a side of the seat of the switching member facing the air passage is provided with a shading slider, the second detecting device is a photosensitive sensor, and the second information is a light intensity, the method further comprises:
when the light intensity is lower than a first value, determining that the switching member is at the first position;
when the light intensity is higher than a second value, determining that the switching member is at the second position, wherein the first value is less than or equal to the second value.

16. The method according to claim 13, wherein the switching member comprises a seat and a pushing piece, the second detecting device is disposed outside an end of the air passage closer to the seat, the seat is a magnetic member, the second detecting device is a Hall sensor, and the second information is a magnetic force value, the method further comprises:
when the magnetic force value obtained by the second detecting device is higher than a third value, determining that the switching member is at the first position;
when the magnetic force value obtained by the second detecting device is lower than a fourth value, determining that the switching member is at the second position, wherein the third value is greater than or equal to the fourth value.

17. The method according to claim 13, further comprising:
in case that the second power supplying circuit is opened, controlling the connectivity of the first power supplying circuit according to a pressing signal corresponding to the on-off key.

18. A controlling device for an electronic cigarette, comprising:
an obtaining device, configured to obtain second information detected by a second detecting device, wherein the second information is configured to indicate a position of a switching member;
a first controlling device, configured to, when the second information indicates that the switching member is at a first position, control a second power supplying circuit between a first detecting device and a battery to be open, wherein first information detected by the first detecting device is configured to indicate whether the electronic cigarette is in a state of being sucked;
a second controlling device, configured to, when the second information indicates that the switching member is at a second position, control the second power supplying circuit to be closed, and control a connectivity of a first power supplying circuit according to the first information reported by the first detecting device, wherein the battery is connected to an atomizing device through the first power supplying circuit.

19. The controlling device according to claim 18, wherein the first controlling device is further configured to, in case that the second power supplying circuit is opened, control the connectivity of the first power supplying circuit according to a pressing signal corresponding to the on-off key.

20. The controlling device according to claim 18, wherein the second controlling device is further configured to, in case that the second power supplying circuit is closed, stop controlling the connectivity of the first power supplying circuit according to a pressing signal corresponding to an on-off key.
